(19) United States
(12) Patent Application Publication
(10) Pub. No.: US 2017/0021493 A1
(43) Pub. Date: Jan. 26, 2017

(54) Sticky Mark Apparatus For Marking A Wall To Facilitate Hanging An Item

(71) Applicant: Sticky Mark LLC, Arlington, TX (US)

(72) Inventor: Yaman Subei, Arlington, TX (US)

(73) Assignee: Sticky Mark LLC, Arlington, TX (US)

(21) Appl. No.: 15/216,170

(22) Filed: Jul. 21, 2016

Related U.S. Application Data
(60) Provisional application No. 62/231,949, filed on Jul. 21, 2015.

(51) Int. Cl. B25H 7/04

(52) U.S. Cl. CPC B25H 7/04

(57) ABSTRACT

The present invention is generally related to an apparatus for facilitating the hanging of an item on a wall, and more particularly related to a removable and reusable apparatus for marking a precise location on a wall to facilitate hanging an item on the wall via an attachment at the precise location. An exemplary embodiment of the herein disclosed apparatus for marking a wall to facilitate handing an item may include: an adhesive housing having an adhesive surface and an adhesive backing to cover the adhesive surface before and after use; a protruding body that protrudes from the adhesive housing and that holds or anchors a marking device so that the marking device protrudes beyond the end of the protruding body opposite the adhesive housing; and a removable cap that attaches onto the protruding body to cover the marking device during non-use. Both the adhesive housing and the removable cap may have one or more grooves on their outer surface so as to provide a tactile surface for the user to grip during use or during removal.

### CROSS-REFERENCES TO RELATED APPLICATIONS

This non-provisional utility application takes priority to the previously filed provisional application: Application No. 62/231,949, filed 21 Jul. 2015, which is hereby incorporated in its entirety by reference.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BRIEF DESCRIPTION OF THE INVENTION

The present invention is generally related to an apparatus for facilitating the hanging of an item on a wall, and more particularly related to a removable and reusable apparatus for marking a precise location on a wall to facilitate hanging an item on the wall via an attachment at the precise location. An exemplary embodiment of the herein disclosed apparatus for marking a wall to facilitate handing an item may include: an adhesive housing having an adhesive surface and an adhesive backing to cover the adhesive surface before and after use; a protruding body that protrudes from the adhesive housing and that holds or anchors a marking device so that the marking device protrudes beyond the end of the protruding body opposite the adhesive housing; and a removable cap that attaches onto the protruding body to cover the marking device during non-use. Both the adhesive housing and the removable cap may have one or more grooves on their outer surface so as to provide a tactile surface for the user to grip during use or during removal.

### BACKGROUND OF THE INVENTION

The present invention is generally related to an apparatus for facilitating the hanging of an item on a wall, and more particularly related to an apparatus for marking a precise location on a wall to facilitate hanging an item on the wall via an attachment at the precise location.

All around the world, people decorate interior and exterior walls of homes, offices, and public buildings by hanging a wide variety of items on their walls. Such items may be pictures, paintings, informational posters, signs, or credentials such as framed diplomas, degrees, or licenses, etc. These items are usually framed, and the frames usually include some sort of attachment system to allow the items to be attached to the wall. The attachment system may be a hook or a wire that allows the item to be hung on a nail embedded into the wall. Often in order to hang such items, a person must employ guesswork or trial and error because the nail cannot be embedded into the wall while the item is in the desired location due to the item itself covering the location for the nail. This is a well-known problem and there have been many devices and apparatus produced for the purpose of alleviating some or all of the frustration caused by using guesswork or trial and error to hang decorative, informational, or functional items on walls.

U.S. Patent Application Publication No. 2011/0174953 to Ruiz et al. (“Ruiz et al.”) discloses a picture hanging marker that consists of an adhesive coating on one side and a marking device recessed within an encasement sleeve on the other side, wherein the encasement sleeve protrudes further than the marking device so that only when significant force is applied to the picture frame, does the marking device protrude from the encasement sleeve enough to mark the wall. Ruiz et al. does alleviate some of the guesswork required to hang a picture frame. But the Ruiz et al. recessed design forces a user to press on the picture itself (or the item being hung itself) with significant force in order to make the desired mark on the wall. When the user presses with sufficient force, the picture or item can be damaged or forced out of the frame. The Ruiz et al. disclosure does not include a cap for the marking device, instead relying on the encasement sleeve and the recessed marking device to prevent unwanted markings. And furthermore, the Ruiz et al. disclosure does not include any significant height between the adhesive surface and the marking device to allow a user to apply sufficient force so as to remove the marking apparatus from the picture frame after use. The Ruiz et al. device's low profile (the marking device does not protrude with any significant height from the adhesive surface) makes it more difficult for a user to remove the device from the picture frame after use.

U.S. Pat. No. 7,234,245 to Tatum (“Tatum”) discloses an apparatus and method, very similar to Ruiz et al., for precisely locating and marking where to fasten an object on a wall. The Tatum device also requires the application of significant force during use to compress the compressible material in order to allow the marking device to make a mark on the wall. And much like Ruiz et al., Tatum does not disclose a cap for the marking device. Also as in Ruiz et al., Tatum does not disclose any significant height between the adhesive surface and the marking device to allow a user leverage to apply sufficient force so as to remove the marking apparatus from the picture frame following use.

U.S. Pat. No. 6,574,880 to Lombardo (“Lombardo”) discloses a marker for indicating a location to place a fastener for an object to be placed on a supporting surface. As with the references previously discussed, Lombardo does not disclose the use of a cap to cover the marking device when the marker is not in use. And Lombardo also does not disclose a body, encasement, or housing having any significant height. A user attempting to remove the Lombardo apparatus from a picture frame after use would have difficulty creating leverage to apply sufficient force for removal.

U.S. Pat. No. 7,958,648 to MacConnell (“MacConnell”) discloses a device that provides a means to mark a wall surface to aid in hanging a suspended object comprising an adhesive strip with small sealed plastic bubbles filled with dye or ink. Unlike the presently disclosed invention, a MacConnell device is not reusable because during use of a MacConnell device the dye/ink-filled bubble is broken by user-applied force to create the desired mark. MacConnell also does not disclose the use of a cap for covering the marking device while not in use. And a MacConnell device is also not easily removed from the picture frame after use, because like Ruiz et al, Tatum, and Lombardo, MacConnell does not disclosure any significant height in the body or encasement of the marking device. So a user of a MacConnell device would also have difficulty creating leverage to apply sufficient force for removal.

As disclosed, the references provide less than ideal solutions to the age old problem of hanging an item on a wall. There remains a need for a simple and reusable apparatus for marking a wall to facilitate hanging an item, wherein the apparatus is able to make a mark on the wall without the need for applying substantial direct pressure on the item to be hung and wherein the apparatus is reliably reusable because the apparatus can easily be removed from the item after use and because the marking device may be capped during non-use. The herein disclosed sticky mark apparatus for marking a wall to facilitate hanging an item provides just such a simple and reusable apparatus.

### BRIEF DESCRIPTION OF THE SEVERAL VIEWS OF THE DRAWING

FIG. 1 illustrates a general overview of an embodiment of a sticky mark apparatus for marking a wall to facilitate hanging an item, in accordance with the present invention;

FIG. 2 illustrates an exploded view of an embodiment of a sticky mark apparatus for marking a wall to facilitate hanging an item, in accordance with the present invention; and

FIG. 3 illustrates an embodiment of a sticky mark apparatus for marking a wall to facilitate hanging an item while two of the apparatus are in use to hang an item, in accordance with the present invention.

### DETAILED DESCRIPTION OF THE INVENTION

The present invention is generally related to an apparatus for facilitating the hanging of an item on a wall, and more particularly related to a removable and reusable apparatus for marking a precise location on a wall to facilitate hanging an item on the wall via an attachment at the precise location. An exemplary embodiment of the herein disclosed apparatus for marking a wall to facilitate handing an item may include: an adhesive housing having an adhesive surface and an adhesive backing to cover the adhesive surface before and after use; a protruding body that protrudes from the adhesive housing and that holds or anchors a marking device so that the marking device protrudes beyond the end of the protruding body opposite the adhesive housing; and a removable cap that attaches onto the protruding body to cover the marking device during non-use. Both the adhesive housing and the removable cap may have one or more grooves on their outer surface so as to provide a tactile surface for the user to grip during use or during removal.

The herein disclosed apparatus for marking a wall to facilitate hanging an item may be referred to as “sticky mark”, the “sticky mark apparatus”, the “sticky mark device”, or the sticky mark apparatus for marking a wall to facilitate handing an item. The herein disclosed apparatus may be used by a person attempting to hang an item on a wall, and such a person may be referred to as a “user” of the herein disclosed apparatus. The item to be hung on a wall may be any sort of decorative, functional, or informational item that the user wishes to have adorn the wall. For example, the item may be a framed picture, a painting, a poster, a shelf or shelving unit, etc.

A user may use the herein disclosed apparatus by (1) peeling the adhesive backing off of the adhesive housing; (2) placing the adhesive surface, and thus the entire apparatus, directly onto the back of the item to be hung in the location of the item's wall-attachment mechanism—at the location of the item's hook, for example; (3) removing the cap from the apparatus; and (4) holding the item facing the wall and gently pushing the item towards the wall at the desired hanging location until the marking device touches the wall and thus marks the exact location where the wall fastener (a nail, for example) should be inserted into the wall. By utilizing the herein disclosed sticky mark apparatus in this manner, the user is able to mark the wall in exactly the specific location where the wall fastener should be inserted to hang the item at the desired position, without needing to resort to guesswork, trial and error, or extensive measurement and line drawing.

Once the wall is marked as described above, the user may then (1) replace the removable cap back onto the protruding body of the apparatus, and (2) remove the apparatus from the item by gently applying force to the removable cap and/or the protruding body in a direction parallel to the item (and in perpendicular to the protruding body) so as to tilt or rock the adhesive surface (and the adhesive housing) of the apparatus off of the item. Once the apparatus is removed from the item after use, the adhesive backing may be reapplied to the adhesive surface. The herein disclosed apparatus may then be stored, with the removable cap attached and the adhesive backing in place, during any period of non-use.

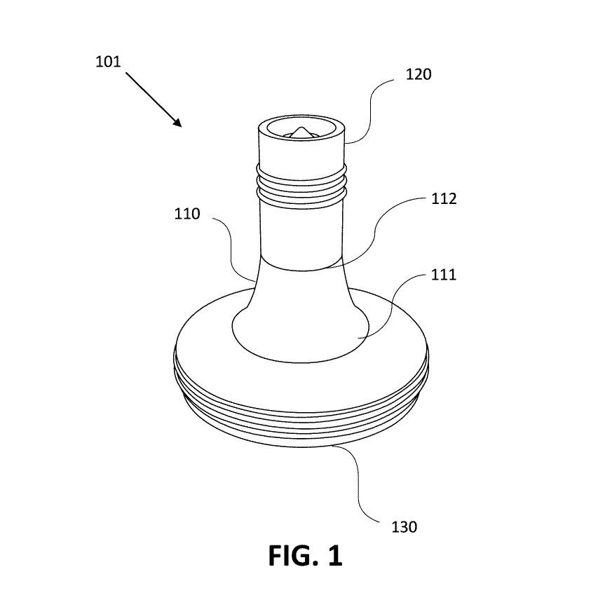

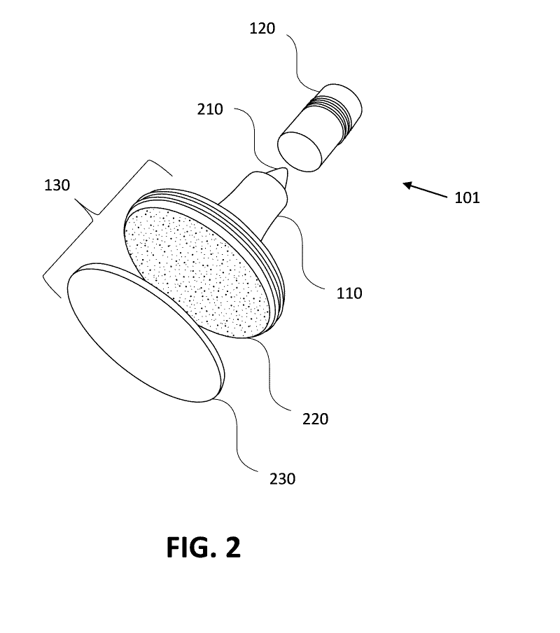

Referring to FIG. 1, the herein disclosed sticky mark apparatus for marking a wall to facilitate hanging an item is illustrated with all its components attached and in-place, as would be the case either before use or after use while the apparatus is in storage for future re-use. Apparatus for marking a wall to facilitate hanging an item 101 includes adhesive housing 130, protruding body 110, and removable cap 120. Adhesive housing 130 may be round (or circular) in shape and may have an adhesive housing radius of approximately 0.5 inches. In alternative embodiments, adhesive housing 130 (and the entire apparatus 101) may be significantly smaller to facilitate the hanging of smaller items, or alternatively adhesive housing 130 (and the entire apparatus 101) may be significantly bigger to facilitate the hanging of larger items. As shown in FIG. 1, adhesive housing 130 may include one or more adhesive housing grooves (which may be referred to simply as grooves). The one or more adhesive housing grooves may be formed on the outer surface of adhesive housing 130, and these adhesive housing grooves function to provide a tactile surface for the user to grip while manipulating apparatus for marking a wall to facilitate hanging an item 101. Adhesive housing 130 (besides the portions of adhesive housing 130 forming adhesive surface 220—not seen in FIG. 1 but visible in FIG. 2) may be formed of any material capable of being formed into the proper shape, as will be appreciated by those skilled in the art, but ideally adhesive housing 130 may be formed of a suitable plastic through injection molding, as is known in the art.

Protruding body 110 protrudes from adhesive housing 130 and may also be of a round, or circular, shape similar to adhesive housing 130. In some embodiments, and as illustrated in the Figures, protruding body 110 has a protruding body radius that is smaller than the adhesive body radius. Protruding body 110 may include a first protruding body radius 111 and a second protruding body radius 112, and first protruding body radius 111 may be larger than second protruding body radius 112. In such an embodiment, the radius of protruding body 110 may gradually decrease further from adhesive housing 130, thus formed substantially a cylindrical shape for protruding body 110. Protruding body 110 may have a protruding height, the protruding height being the length of protruding body 110 from the end of protruding body 110 in contact with adhesive housing 130 to the distal end (opposite end) of protruding body 110. In an exemplary embodiment, the protruding height may be approximately 0.9375 inches so as to allow the user sufficient leverage to apply a gentle force for removing apparatus 101 from the item to be hung. In this embodiment, the total height of apparatus 101 may be approximately 1.1875 inches. Alternatively, in an exemplary embodiment the protruding height may be at least 0.7500 inches, again allowing the user sufficient leverage to apply force for removing apparatus 101 from the item to be hung. Protruding body 110 includes, or anchors, a marking device, which is not visible in the fully assembled view of FIG. 1 but which can be seen in the exploded view illustrated in FIG. 2. Protruding body 110 may be formed of any material capable of being formed into the proper shape, as will be appreciated by those skilled in the art, but ideally protruding body 110 may be formed of a suitable plastic through injection molding, as is known in the art. Protruding body 110 may be rigid, or sufficiently rigid so as to avoid deforming (or substantially deforming) during use—meaning that protruding body 110 need not deform or recess during use in order to expose the marking device anchored within, because, as can be seen in FIG. 2, marking device 210 protrudes beyond the distal end of protruding body 110 and is exposed and therefore usable for marking once removable cap 120 is removed.

Removable cap 120 attaches onto the distal end of protruding body 110. Removable cap 120 may be formed of any material capable of being formed into the proper shape, as will be appreciated by those skilled in the art, but ideally removable cap 120 may be formed of a suitable plastic through injection molding, as is known in the art. Removable cap 120 may snap into place on protruding body 110, as is known in the art, while being capable of easy removal by a user applying force, as is known in the art. In an ideal embodiment of the herein disclosed apparatus, removable cap 120 includes one or more cap grooves (which may be referred to simply as “grooves”) formed onto the outer surface of removable cap 120. The one or more cap grooves may provide a tactile surface for the user to grip while manipulating removable cap 120 or while manipulating the entire apparatus for marking a wall to facilitate hanging an item 101.

Referring to FIG. 2, an exploded view of the components which may comprise the herein disclosed apparatus for marking a wall to facilitate hanging an item is illustrated. Apparatus for marking a wall to facilitate hanging an item 101 includes adhesive housing 130 having adhesive surface 220 and adhesive backing 230; protruding body 110 anchoring marking device 210; and removable cap 120. Adhesive surface 220 is positioned underneath, or on the bottom of, adhesive housing 130, with adhesive backing 230 covering adhesive surface 220. Adhesive surface 220 may be formed of any adhesive, or sticky, material that will provide sufficient adhesive qualities to keep apparatus 101 in place during use, but which will allow for relatively easy removal through application of force by the user, as is known in the art. Adhesive backing 230 may be formed of any material flexible enough to be easily removed by a user with a peeling motion, while being sturdy enough to allow for reattachment onto adhesive surface 220 after use, as is known in the art.

Marking device 210 may be anchored within protruding body 110 so that at least a portion of marking device 210 protrudes beyond the distal end of protruding body 110. Alternatively, marking device 210 may be attached onto the distal end of protruding body 110. Marking device 210 may be any sort of device capable of making a mark on a wall, or capable or deforming the wall in such a way as to indicate a precise location on the wall. For example, marking device 210 may be a marker, a washable marker, a pen, a pencil, chalk, or a hollow pin containing ink. Alternatively, marking device 210 may simply be a material forming a sharp point for making a visible (or otherwise apparent) hole or indentation on the surface of the wall. Such a material forming a sharp point may be a metal, a hard plastic, or another material as will be apparent to those skilled in the art.

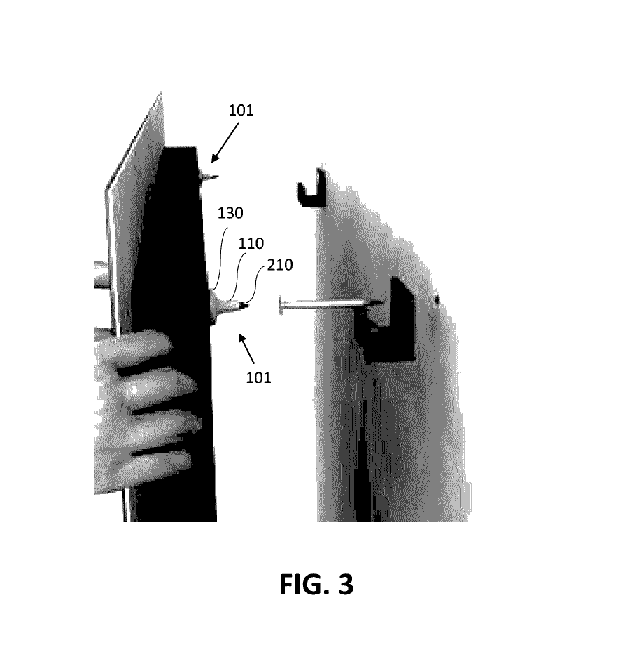

Referring to FIG. 3, two of the herein disclosed apparatus for marking a wall to facilitate hanging an item are illustrated in use after the user has attached apparatus 101 to the item (a framed picture) and removed removable caps 120. As can be seen, if an item to be hung requires two nails for hanging, two apparatus 101 may be used simultaneously, for example. For each apparatus, adhesive housing 130 can be seen attached (via adhesive surfaces 220, not visible in FIG. 3) to the item, one in proximity to each upper corner of the item. Removable caps 120 have been removed, showing marking devices 210, anchored in place by protruding bodies 110. Once the user uses the apparatus 101 to make marks on the wall, the user is then able to insert nails and/or additional hardware in the precise location on the wall necessary to hang the item in the desired position.

Throughout this description of several embodiments of the herein disclosed apparatus for marking a wall to facilitate hanging an item, the various components of the apparatus have been described mostly as being round (or circular or cylindrical in shape) as is illustrated in the figures. But those skilled in the art will appreciate that the same components (adhesive housing 130, protruding body 110, removable cap 120, adhesive surface 220, and/or adhesive backing 230) may alternatively be formed to be square (or rectangular or cubic) in shape while still functioning in substantially the same manner. It is therefore intended that such alternative shapes (rectangular and/or cubic) be included herein as alternative embodiments of the herein disclosed apparatus for marking a wall to facilitate hanging an item. In such embodiments, reference to an adhesive housing radius, a protruding body radius (or a first protruding body radius or a second protruding body radius) is intended to cover such alternatively shaped components, meaning that radius in these instances would mean surface area. For example, if some or all of the components where rectangular (cubic) instead of circular (cylindrical), then adhesive housing 130 may have a larger surface area than protruding body 110. All shapes of the herein described components are intended to be included herein.

While the present invention has been illustrated and described herein in terms of a preferred embodiment and several alternatives, it is to be understood that the apparatus described herein can have a multitude of additional uses and applications. Accordingly, the invention should not be limited to just the particular description and various drawing figures contained in this specification that merely illustrate a preferred embodiment and application of the principles of the invention.

What is claimed is:

1. An apparatus for marking a wall to facilitate hanging an item, comprising:
an adhesive housing, the adhesive housing having an adhesive surface and an adhesive backing;
a protruding body;
a marking device, wherein the marking device protrudes beyond the protruding body; and
a removable cap for attaching to the protruding body and covering the marking device during non-use.

2. The apparatus for marking a wall to facilitate hanging an item as recited in claim 1, wherein the marking device is a washable marker.

3. The apparatus for marking a wall to facilitate hanging an item as recited in claim 1, wherein the marking device is chalk.

4. The apparatus for marking a wall to facilitate hanging an item as recited in claim 1, wherein the marking device is a sharp point.

5. The apparatus for marking a wall to facilitate hanging an item as recited in claim 4, wherein the sharp point is formed of a metal.

6. The apparatus for marking a wall to facilitate hanging an item as recited in claim 1, wherein the adhesive housing has an adhesive housing radius of approximately 0.5 inches.

7. The apparatus for marking a wall to facilitate hanging an item as recited in claim 1, wherein the adhesive housing, the protruding body, and the removable cap are formed of a plastic.

8. The apparatus for marking a wall to facilitate hanging an item as recited in claim 1, wherein the adhesive housing has an adhesive housing radius and the protruding body has a protruding body radius, and wherein the adhesive housing radius is larger than the protruding body radius.

9. The apparatus for marking a wall to facilitate hanging an item as recited in claim 1, wherein the adhesive housing has an adhesive housing radius and the protruding body has a first protruding body radius and a second protruding body radius, and wherein the adhesive housing radius is larger than the first protruding body radius, and wherein the first protruding body radius is larger than the second protruding body radius.

10. The apparatus for marking a wall to facilitate hanging an item as recited in claim 1, wherein the adhesive housing includes one or more adhesive housing grooves.

11. The apparatus for marking a wall to facilitate hanging an item as recited in claim 10, wherein the removable cap includes one or more cap grooves.

12. The apparatus for marking a wall to facilitate hanging an item as recited in claim 1, wherein the adhesive housing includes one or more adhesive housing grooves and the removable cap includes one or more cap grooves.

13. The apparatus for marking a wall to facilitate hanging an item as recited in claim 1, wherein the protruding body has a protruding height of approximately 0.9375 inches.

14. The apparatus for marking a wall to facilitate hanging an item as recited in claim 1, wherein the protruding body has a protruding height of at least 0.7500 inches.

15. The apparatus for marking a wall to facilitate hanging an item as recited in claim 1, wherein the protruding body is rigid.

16. An apparatus for marking a wall to facilitate hanging an item, comprising:
an adhesive housing, the adhesive housing having an adhesive surface, an adhesive backing, and an adhesive housing radius;
a protruding body, wherein the protruding body is rigid, the protruding body protrudes at least 0.5 inches from the adhesive housing, and the protruding body has a protruding body radius smaller than the adhesive housing radius;
a marking device, wherein the marking device protrudes beyond the protruding body; and
a removable cap for attaching to the protruding body and covering the marking device during non-use.

17. The apparatus for marking a wall to facilitate hanging an item as recited in claim 16, wherein the marking device is a washable marker.

18. The apparatus for marking a wall to facilitate hanging an item as recited in claim 16, wherein the adhesive housing radius is approximately 0.5 inches.

19. The apparatus for marking a wall to facilitate hanging an item as recited in claim 16, wherein the adhesive housing includes one or more adhesive housing grooves.

20. The apparatus for marking a wall to facilitate hanging an item as recited in claim 16, wherein the removable cap includes one or more cap grooves.
